(19) United States
(12) Patent Application Publication
(10) Pub. No.: US 2015/0292871 A1
(43) Pub. Date: Oct. 15, 2015

(54) IMAGE PROCESSING APPARATUS AND IMAGE PROCESSING METHOD

(71) Applicant: CANON KABUSHIKI KAISHA, Tokyo (JP)

(72) Inventor: Chiaki Kaneko, Yokohama-shi (JP)

(21) Appl. No.: 14/682,414

(22) Filed: Apr. 9, 2015

(30) Foreign Application Priority Data
Apr. 15, 2014 (JP) 2014-083990
Mar. 23, 2015 (JP) 2015-060014

(51) Int. Cl. G01B 11/22; G01B 11/14; G06T 7/00; H04N 5/232

(52) U.S. Cl. CPC G01B 11/22; H04N 5/23212; G01B 11/14; G06T 7/0051

(57) ABSTRACT

Image data is obtained. Distance information of subjects contained in the image data are obtained. A user interface including an image which represents a correspondence between a distance of a subject and image blur is generated. A parameter indicating the correspondence between the subject distance and the image blur is obtained, based on an instruction input through the user interface and to set the correspondence between the subject distance and the image blur. Image data having a blur condition corresponding to the correspondence in accordance with the instruction is generated, based on the image data, the distance information, and the parameter.

### BACKGROUND OF THE INVENTION

1. Field of the Invention

The present invention relates to image processing of controlling the sense of depth of an image.

2. Description of the Related Art

As a technique of representing the sense of depth of an image, there is known photographic representation of focusing on a main subject by decreasing the depth of field, and blurring the foreground or background. The blur amount of the foreground or background (the shape and size of a circle of confusion) is generally decided at the time of image capturing in accordance with optical conditions such as the focal length and effective aperture of a lens used for image capturing and a subject distance indicating the depth to a subject included in the foreground/background.

To the contrary, in recent years, there is known a technique of obtaining information (to be referred to as a “light field” hereinafter) of the direction and intensity of light by adding a new optical element to the optical system of an image capturing apparatus, and allowing adjustment of a focused position and the depth of field by image processing (International Publication No. 2006/039486 (to be referred to as “literature 1” hereinafter)). According to the technique described in literature 1, it is possible to adjust the blur amount of the foreground/background by changing optical conditions in a captured image.

In the technique described in literature 1, setting optical conditions uniquely determines the relationship between the depth of a subject and a blur amount for it. Therefore, for example, it is impossible to change the blur amount of a subject C between a subject A at the front and a subject B behind the subject A with respect to the depth while maintaining the blur amounts of the subjects A and B. In other words, in the technique described in literature 1, it is difficult to adjust only the blur amount of a subject at a specific depth.

### SUMMARY OF THE INVENTION

In one aspect, an image processing apparatus comprising: a first obtaining unit configured to obtain image data; a second obtaining unit configured to obtain distance information of subjects contained in the image data; an interface generation unit configured to generate a user interface including an image which represents a correspondence between a distance of a subject and image blur, and to obtain a parameter indicating the correspondence between the subject distance and the image blur, based on an instruction input through the user interface and to set the correspondence between the subject distance and the image blur; and an image generation unit configured to generate image data having a blur condition corresponding to the correspondence in accordance with the instruction, based on the image data, the distance information, and the parameter.

According to the aspect, it is possible to adjust an image blur of a subject, thereby controlling the sense of depth of the image.

Further features of the present invention will become apparent from the following description of exemplary embodiments with reference to the attached drawings.

### BRIEF DESCRIPTION OF THE DRAWINGS

FIG. 1 is a block diagram showing the arrangement of an information processing apparatus functioning as an image processing apparatus according to an embodiment.

FIG. 2 is a block diagram showing the processing arrangement of the image processing apparatus.

FIGS. 3A and 3B are views for explaining the arrangement of an image capturing apparatus.

FIGS. 4A and 4B are views for explaining a depth estimation method.

FIG. 5 is a view showing an example of a sense-of-depth adjustment UI.

FIG. 6 is a schematic view showing a light field.

FIG. 7 is a flowchart illustrating image generation processing.

FIGS. 8A to 8C are views for explaining image data before adjustment.

FIG. 9 is a view showing an example of a user instruction input through the sense-of-depth adjustment UI.

FIG. 10 is a view showing an example of an image after adjustment.

FIG. 11 is a block diagram showing the processing arrangement of an image processing apparatus according to the second embodiment.

FIG. 12 is a flowchart illustrating image generation processing according to the second embodiment.

FIG. 13 is a block diagram showing the processing arrangement of an image processing apparatus according to the third embodiment.

FIG. 14 is a flowchart for explaining image generation processing according to the third embodiment.

FIGS. 15A and 15B are views respectively showing examples of parallax image data and intermediate image data.

FIGS. 16A and 16B are views respectively showing examples of a distance image before parallax adjustment and a distance image after parallax adjustment.

FIG. 17 is a graph showing an example of the relationship between a depth determined by a blur parameter and the diameter of a circle of confusion.

FIG. 18 is a view showing an example of parallax image data output as output image data.

### DESCRIPTION OF THE EMBODIMENTS

An image processing apparatus and a method therefor according to the present invention will be described in detail below based on preferred embodiments of the present invention with reference to the accompanying drawings. Note that arrangements to be described in the following embodiments are merely examples, and the present invention is not limited to the illustrated arrangements.

### First Embodiment

The first embodiment will exemplify a method of adjusting an image blur amount by controlling the depth of a subject derived from a light field.

[Apparatus Arrangement]

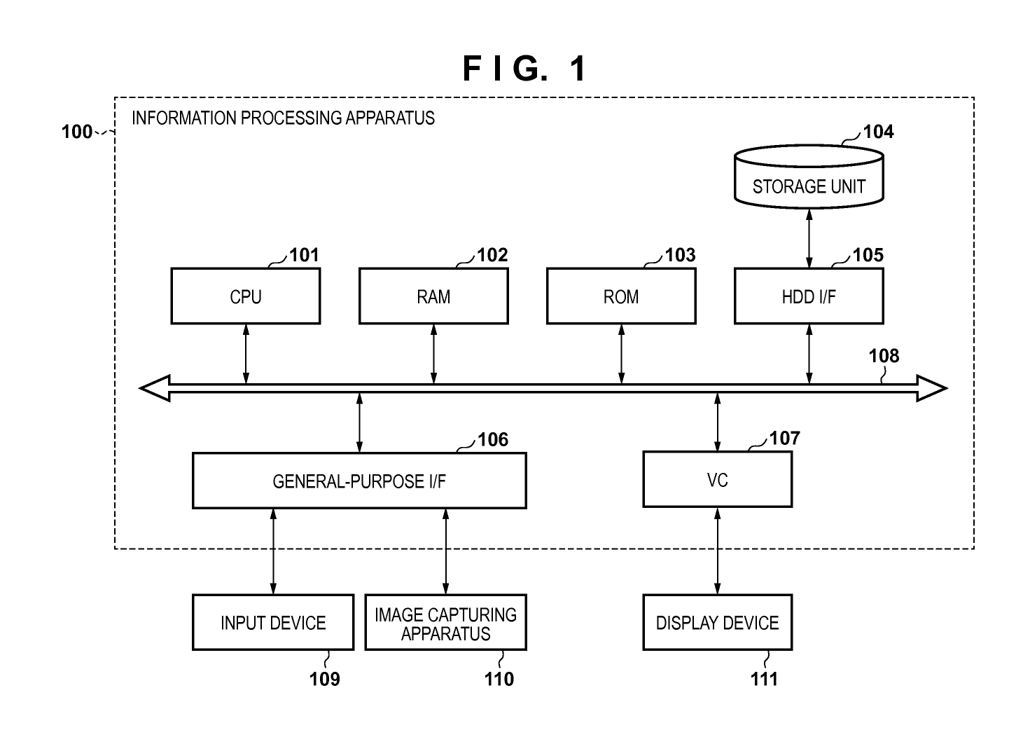

FIG. 1 is a block diagram showing the arrangement of an information processing apparatus 100 functioning as an image processing apparatus according to the embodiment. A microprocessor (CPU) 101 executes programs stored in a read only memory (ROM) 103 and a storage unit 104 such as a hard disk drive (HDD) using a random access memory (RAM) 102 as a work memory, thereby comprehensively controlling respective components (to be described later) through a system bus 108.

An HDD interface (I/F) 105 is an interface such as a serial ATA (SATA) interface, and is connected to the storage unit 104 as a secondary storage device. The CPU 101 can read out data from the storage unit 104 and write data in the storage unit 104 through the HDD I/F 105. The CPU 101 can also load a program and data stored in the storage unit 104 into the RAM 102, and save, in the storage unit 104, data recorded in the RAM 102. The CPU 101 can then execute the program loaded into the RAM 102. Note that the secondary storage device may be a storage medium mounted on a solid-state drive (SSD) or optical disk drive, instead of the HDD.

A general-purpose I/F 106 is a serial bus interface such as a USB (Universal Serial Bus) interface. The general-purpose I/F 106 is connected to an input device 109 such as a keyboard and mouse, and an image capturing apparatus 110 such as a digital camera. The CPU 101 can obtain various data from the input device 109 and image capturing apparatus 110 through the general-purpose I/F 106.

A video card (VC) 107 includes a video output interface such as DVI (Digital Visual Interface) or a communication interface such as HDMI® (High-Definition Multimedia Interface), and is connected to a display device 111 such as a liquid crystal display. The CPU 101 can send image data to the display device 111 through the VC 107 to execute image display.

[Arrangement of Image Processing Apparatus]

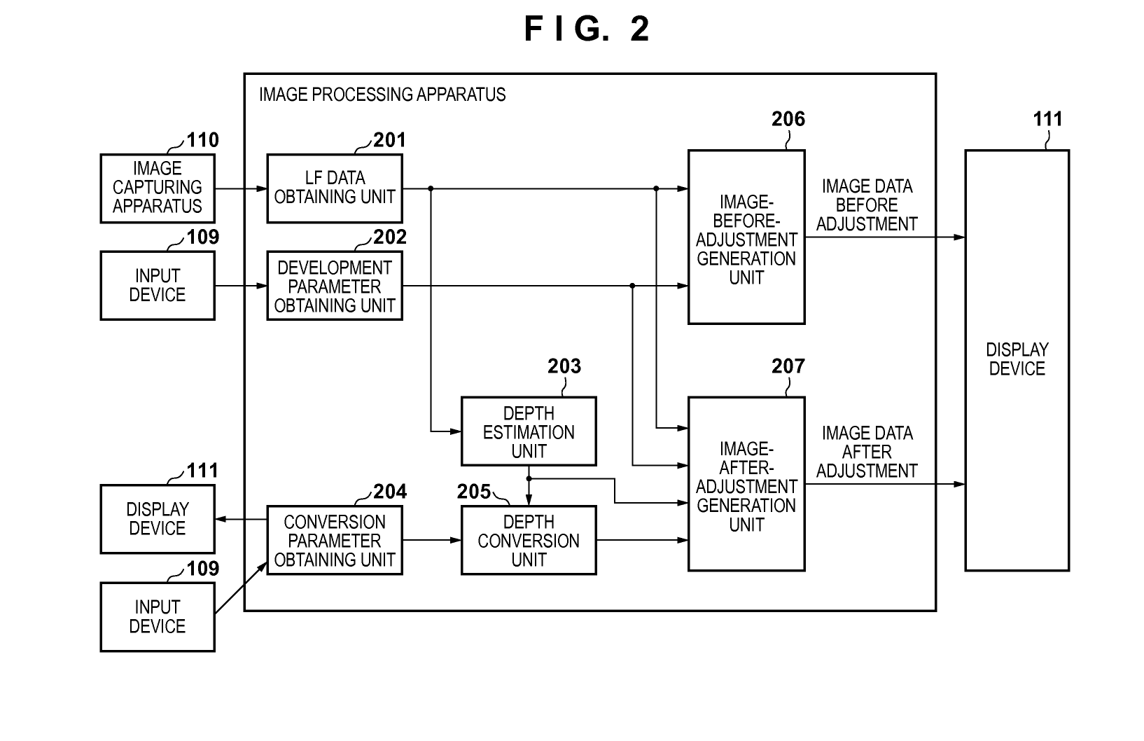

FIG. 2 is a block diagram showing the processing arrangement of the image processing apparatus. The image processing apparatus includes a light-field (LF) data obtaining unit 201, a development parameter obtaining unit 202, a depth estimation unit 203, a conversion parameter obtaining unit 204, a depth conversion unit 205, an image-before-adjustment generation unit 206, and an image-after-adjustment generation unit 207. These components will be explained below.

LF Data Obtaining Unit

The LF data obtaining unit 201 obtains light-field data from the image capturing apparatus 110 through the general-purpose I/F 106. For example, a plenoptic camera (light-field camera) in which a microlens array is disposed between a main lens and an image capturing device is used as the image capturing apparatus 110.

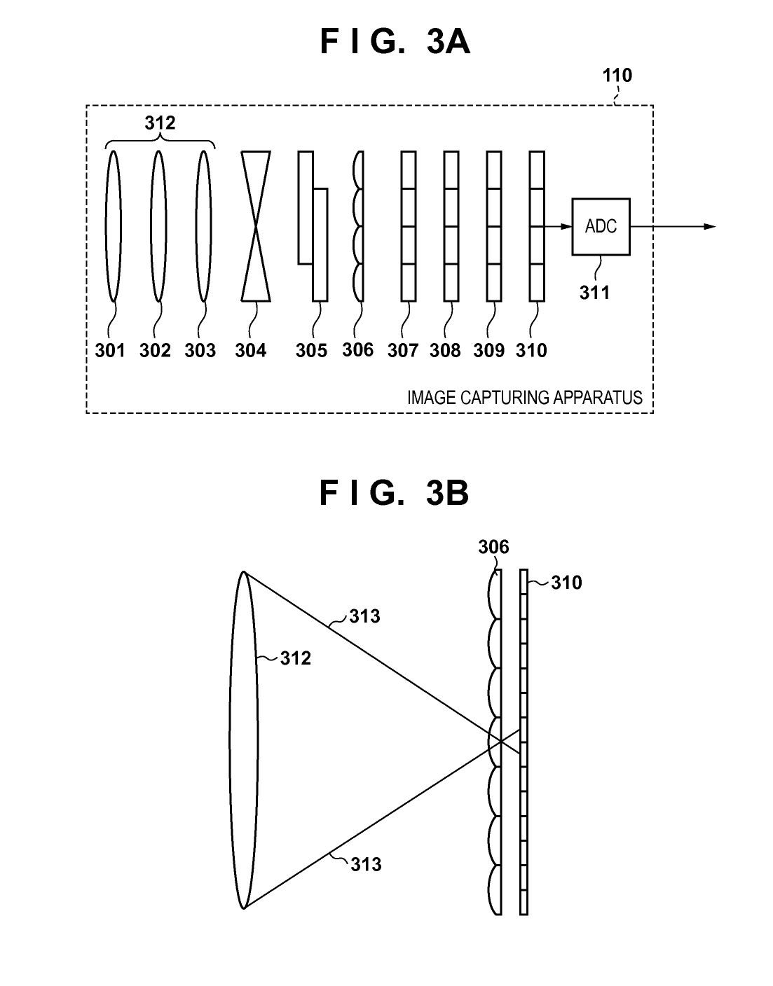

The arrangement and concept of a general plenoptic camera will be described with reference to FIGS. 3A and 3B. Referring to FIG. 3A, lenses 301 to 303 serve as the zoom lens 301, focus lens 302, and blur correction lens 303, respectively, and are collectively expressed as one main lens 312. A ray 313 which enters through the main lens 312 reaches a microlens array (MLA) 306 through a diaphragm 304 and a shutter 305. The ray 313 having passed through the MLA 306 reaches an image capturing device 310 through an optical low-pass filter 307, an infrared cut filter 308, and a color filter array 309. An analog-to-digital converter (ADC) 311 converts an analog signal output from the image capturing device 310 into a digital signal.

In the plenoptic camera, the MLA 306 is disposed between an image capturing optical system (for example, the main lens 312, diaphragm 304, and shutter 305) and the various filters 307 to 309 to obtain a light field for discriminating coordinates on the main lens 312 through which the ray 313 has passed. In FIG. 3B, the ray 313 having passed through the main lens 312 reaches one of image sensors of the image capturing device 310 corresponding to a unit lens of the MLA 306 disposed on an imaging plane. Referring to FIG. 3B, if unit lenses and image sensors are also arranged in a direction perpendicular to the sheet surface in the same manner, it is possible to discriminate between light having passed through the upper half of the main lens 312 and light having passed through the lower half of the main lens 312, and between light having passed through the left half of the main lens 312 and light having passed through the right half of the main lens 312. That is, it is possible to discriminate among light beams entering from the upper left, lower left, lower right, and upper right directions with respect to a unit lens.

Note that the image capturing apparatus 110 is not limited to the plenoptic camera, and may be any camera capable of obtaining a light field at a sufficient angle/spatial resolution, such as a multiple-lens camera in which a plurality of small cameras are arranged.

The LF data obtaining unit 201 obtains next data from the image capturing apparatus 110 through the general-purpose I/F 106. The first data is light-field data indicating the direction and intensity of light in the light field obtained by shooting by the image capturing apparatus 110. The second data is focal length information indicating a focal length f of the main lens 312 at the time of shooting of the light field. The obtained light-field data and focal length information are supplied to the depth estimation unit 203, image-before-adjustment generation unit 206, and image-after-adjustment generation unit 207.

Development Parameter Obtaining Unit

The development parameter obtaining unit 202 obtains development parameters to be used to generate an image from the light-field data and focal length information. For example, the development parameter obtaining unit 202 obtains, as development parameters, an f-number and a focused position indicating the depth of field of an image to be generated from a user instruction input by the input device 109. The obtained development parameters are supplied to the image-before-adjustment generation unit 206 and image-after-adjustment generation unit 207.

Depth Estimation Unit

The depth estimation unit 203 estimates information (to be referred to as “depth-before-adjustment information” hereinafter) indicating the depth of a subject using the light-field data and focal length information. The depth of the subject indicates the distance (subject distance) between the subject and the main lens 312.

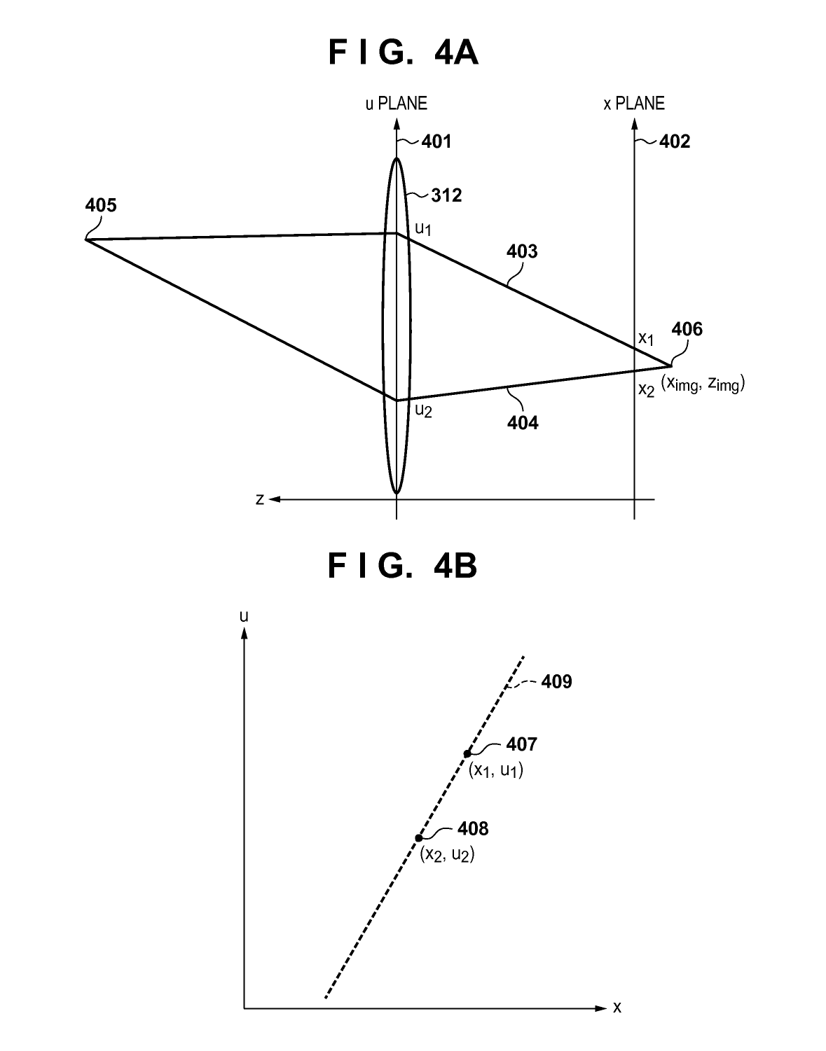

A depth estimation method will be described with reference to FIGS. 4A and 4B. FIG. 4A shows a point 405 on a subject and rays 403 and 404 which enter the main lens 312 from the point 405. FIG. 4B shows a graph in which the rays 403 and 404 shown in FIG. 4A are plotted on a light-field coordinate system.

Referring to FIG. 4A, planes 401 and 402 are virtually disposed in parallel to each other, and will be referred to as a u plane and x plane, respectively. In fact, the u plane 401 and x plane 402 are two-dimensional planes but are expressed as one-dimensional planes in FIG. 4B for the sake of convenience. FIG. 4B shows a case in which the x plane 402 is set as an imaging plane and the u plane 401 is disposed on the principal plane of the main lens 312. However, the u plane 401 may be disposed at another position as long as it is parallel to the x plane 402. A direction intersecting the x plane 402 and u plane 401 from the x plane 402 to the u plane 401 is defined as a z-axis. Thus, the z-axis indicates a depth direction.

The rays 403 and 404 exit from the point 405, and are refracted by the main lens 312. When positions at which a ray passes through the u plane 401 and x plane 402 are expressed by (x, u), the ray 403 passes through (x1, u1) and the ray 404 passes through (x2, u2). The passing positions of the rays 403 and 404 are plotted on the light-field coordinate system by plotting x along the abscissa and u along the ordinate, thereby obtaining the graph shown in FIG. 4B. As shown in FIG. 4B, in the light-field coordinate system, a point 407 indicates the passing positions (x1, u1), and a point 408 indicates the passing positions (x2, u2). In this way, a plurality of rays in a shooting scene space can be expressed as a plurality of points having different coordinates on the light-field coordinate system.

Considering all rays passing through a given point in a shooting scene, the characteristic in which a set of points, on the light-field coordinate system, corresponding to the rays forms a straight line is known. For example, a set of points, on the light-field coordinate system, corresponding to a plurality of rays exiting from a given point (for example, the point 405) on the subject is expressed as a straight line 409, and the gradient of the straight line 409 changes according to the distance from the u plane 401 to the subject. In FIG. 4A, let (x_{img}, z_{img}) be the coordinates of a point 406 conjugate with the point 405, and zᵤ be a z-coordinate on the u plane. Assume that the point 406 is a point externally dividing the u plane 401 and x plane 402 at α:(1−α) in the z-axis direction. In this case, all rays passing through the point 406 satisfy:

αx−(α−1)u=x_{img} (1)

where α=(zᵤ+z_{img})/zᵤ

Equation (1) represents the straight line 409 shown in FIG. 4B. By obtaining the gradient of the straight line 409, it is possible to estimate depth-before-adjustment information indicating the distance between the main lens 312 and the subject. That is, it is possible to obtain the value of a in equation (1) by regarding, as an image, a set of points obtained by plotting the passing positions (x, u) of each ray on the light-field coordinate system, extracting an edge of the image, and determining the gradient of the extracted edge. Since the z-coordinate zᵤ on the u plane is known, it is possible to obtain the z-coordinate z_{img} of the point 406 using the value of α. It is then possible to estimate depth-before-adjustment information indicating the distance (subject distance) from the principal point of the lens on the u plane 401 to the point 405 on the subject using a formula of the lens based on the obtained value z_{img} and the focal length f.

The depth estimation unit 203 estimates depth-before-adjustment information for all subjects included in the shooting scene, and supplies the estimated depth-before-adjustment information to the depth conversion unit 205 and image-after-adjustment generation unit 207.

Note that a case in which a subject distance is used as information indicating the depth of a subject will be described. However, the distance between the point 406 and the x plane 402 which can be calculated from the light-field data or the distance between the u plane 401 and the point 406 can be used as depth information.

Conversion Parameter Obtaining Unit

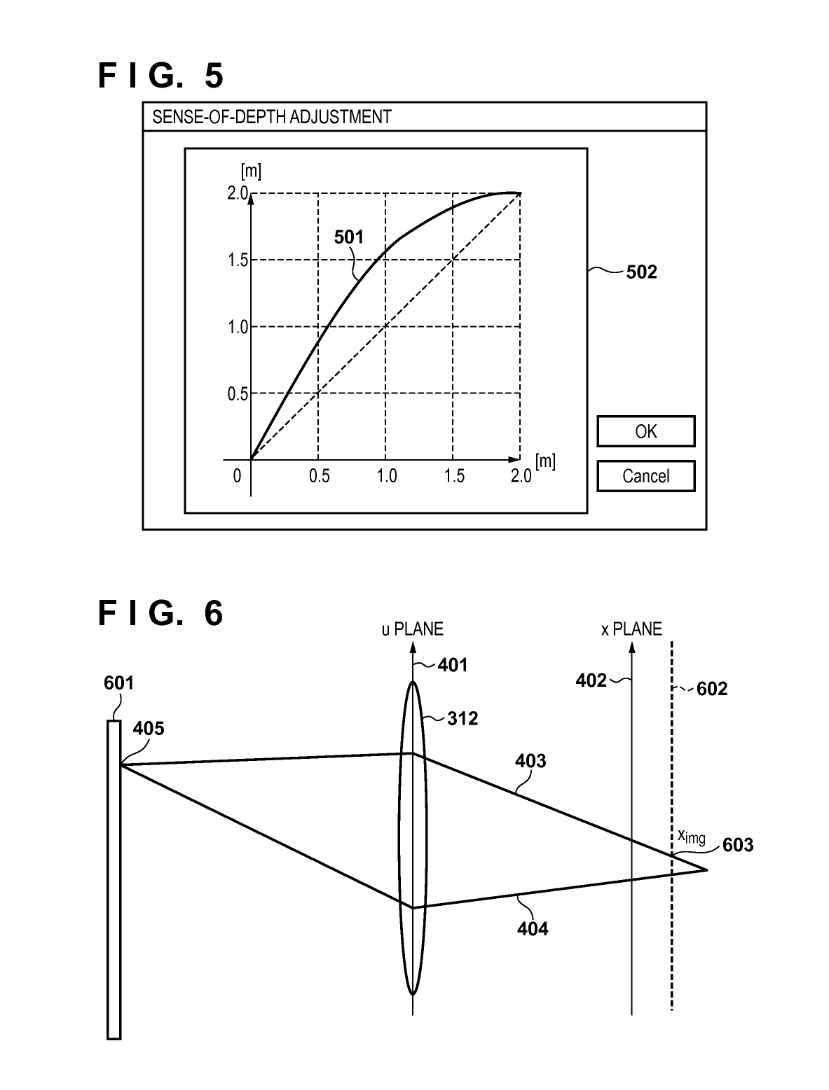

The conversion parameter obtaining unit 204 creates a conversion parameter for converting the subject distance indicated by the depth-before-adjustment information estimated by the depth estimation unit 203 into a subject distance to be represented on an image. The conversion parameter obtaining unit 204 displays, on the display device 111, a user interface (to be referred to as a “sense-of-depth adjustment UI” hereinafter) for adjusting the sense of depth shown in FIG. 5, obtains a user instruction input through the UI, and creates a conversion parameter based on the user instruction.

In a graph 502 displayed on the sense-of-depth adjustment UI shown in FIG. 5, the abscissa represents an (actual) subject distance before adjustment and the ordinate represents a (virtual) subject distance after adjustment. A curve 501 indicates the correspondence between the subject distances. The graph 502 need only represent the correspondence between the depths before and after adjustment, and may be a graph in which the abscissa represents a subject distance from a focused position before adjustment and the ordinate represents a subject distance from a focused position after adjustment.

The user arbitrarily modifies the shape of the curve 501 shown in FIG. 5, and instructs the position of the subject in the depth direction. The conversion parameter obtaining unit 204 creates a conversion parameter which satisfies the correspondence between the depths before and after adjustment represented by the curve 501, and supplies the created conversion parameter to the depth conversion unit 205. Note that a conversion table represented by a lookup table (LUT), a conversion matrix, a conversion function, or the like can be used as a conversion parameter.

Note that the sense-of-depth adjustment UI may be a UI which presents, to the user, the correspondence between the level of a blur occurring at the actual subject distance and that of a blur occurring at the subject distance to be represented on an image. In this case, at least one of the abscissa and ordinate of the sense-of-depth adjustment UI may indicate the level of a blur.

Depth Conversion Unit

The depth conversion unit 205 converts the subject distance included in the depth-before-adjustment information estimated by the depth estimation unit 203 into a subject distance to be represented on an image in accordance with the conversion parameter created by the conversion parameter obtaining unit 204. The depth conversion unit 205 supplies, as depth-after-adjustment information, the subject distance obtained by conversion to the image-after-adjustment generation unit 207.

Image-Before-Adjustment Generation Unit

The image-before-adjustment generation unit 206 generates image data before adjustment using the light-field data, focal length information, and development parameters. A method of generating image data before adjustment will be explained with reference to a schematic view showing the light field in FIG. 6. In fact, the light-field space is a four-dimensional space. In FIG. 6, however, the light-field space is expressed as a two-dimensional space for the sake of convenience. The same reference numerals as those in FIG. 4B denote that same elements in FIG. 6 and a detailed description thereof will be omitted.

Referring to FIG. 6, an image formed on a virtually disposed virtual image sensor plane 602 is generated from the light field. Let x_{img} be the coordinate (pixel position) of a point 603 on the virtual image sensor plane 602. Then, based on equation (1), light passing through the point 603 is given by:

x=x_{img}/α+(1−1/α)u (2)

where α represents a position on the z-axis of the virtual image sensor plane 602.

Let 2D be the diameter of the aperture of the diaphragm 304. Then, a pixel value I(x_{img}) of the point 603 is given by:

$$\begin{matrix}I ( {x}_{img} ) = {\int }_{- D}^{D} L ( x , u ) d u \\ = {\int }_{- D}^{D} L \{ {X}_{img} / α + ( 1 - 1 / α ) u , u \} d u\end{matrix} \qquad ( 3 )$$

In equation (3), L(x, u) represents the intensity of light whose passing positions on the u plane 401 and x plane 402 are indicated by (x, u). Equation (3) is used to calculate the intensity of light which passes through the aperture and converges to the point 603. In equation (3), α represents the position (z-coordinate) of the virtual image sensor plane 602. Therefore, changing α is equivalent to changing the position on the virtual image sensor plane 602. By changing the integration range [−D, D] in equation (3), it is possible to virtually change the aperture of the diaphragm 304. When the focused position of the development parameters is given as the value of α, and an integration range [−f/(2F), f/(2F)] is given based on the f-number F and the focal length f of the lens of the image capturing apparatus 110, it is possible to obtain an image with a desired depth of field according to equation (3). Assume that a relationship of F=f/(2D) is satisfied among the diameter 2D of the aperture, the focal length f, and the f-number F.

The image data generated by the image-before-adjustment generation unit 206 is supplied to the display device 111 as image data before adjustment. An image before adjustment is displayed on the display device 111. The user can modify the shape of the curve 501 through the sense-of-depth adjustment UI shown in FIG. 5 with reference to the image based on the image data before adjustment as a reference image.

Image-After-Adjustment Generation Unit

The image-after-adjustment generation unit 207 obtains a blur amount (to be referred to as a “target blur amount” hereinafter) when the subject is at the depth position after adjustment using the focal length information, development parameters, and depth-after-adjustment information. Based on the depth-before-adjustment information, the image-after-adjustment generation unit 207 calculates, for each pixel position, the diameter 2D of the aperture for reproducing the target blur amount. The image-after-adjustment generation unit 207 then generates image data after adjustment by calculating the intensity of light passing through the aperture and converging to the pixel position x_{img} based on the light-field data.

The image-after-adjustment generation unit 207 assumes that the subject is at a depth position z′_{obj}(x_{img}) after adjustment with respect to the pixel position x_{img}. On this assumption, the image-after-adjustment generation unit 207 calculates a diameter 2R(x_{img}) of a circle of confusion. By using the focal length f, f-number F, and focused position α, the diameter 2R(x_{img}) of the circle of confusion is given by:

2R(x_{img})=(f²/Fα)·|z′_{obj}(x_{img})−α|/z′_{obj}(x_{img}) (4)

The image-after-adjustment generation unit 207 calculates a diameter 2D′(x_{img}) of the aperture when the diameter of a circle of confusion for a depth position z_{obj}(x_{img}) before adjustment equals 2R(x_{img}) obtained by equation (4), as given by:

2D′(x_{img})=2R(x_{img})·(α/f)·{z_{obj}(x_{img})/|z_{obj}(x_{img})α|} (5)

The image-after-adjustment generation unit 207 generates image data after adjustment by calculating:

I(x_{img})=∫_{-d}^{d} L{X_{img}/α+(1−1/α)u, u}du (6)

where d=D′(x_{img})

Equation (6) is obtained by setting the integration range of equation (3) to [−D′(x_{img}), D′(x_{img})].

The image data after adjustment generated by the image-after-adjustment generation unit 207 is supplied to the display device 111, and an image after adjustment is displayed on the display device 111. The image displayed based on the image data after adjustment is drawn with a blur amount which makes it look as if the subject were at the depth position after adjustment.

[Image Generation Processing]

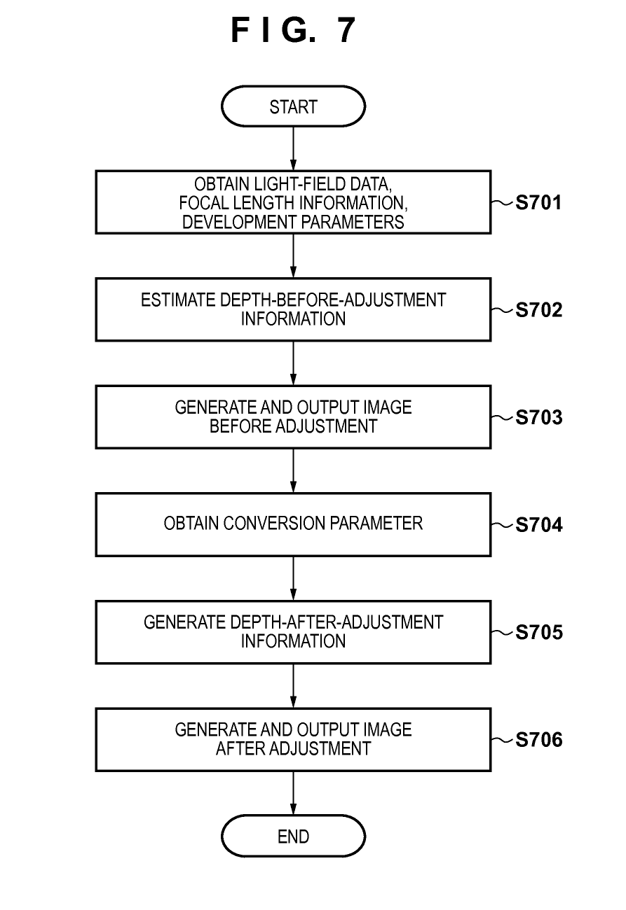

FIG. 7 is a flowchart illustrating image generation processing executed by the image processing apparatus. The processing shown in FIG. 7 is implemented when the CPU 101 loads a program, in which the following procedure is described and which is executable by a computer, from the storage unit 104 into the RAM 102, and executes the program.

The LF data obtaining unit 201 obtains light-field data and focal length information from the image capturing apparatus 110, and the development parameter obtaining unit 202 obtains development parameters from the input device 109 (S701).

The depth estimation unit 203 estimates depth-before-adjustment information using the obtained light-field data and focal length information (S702).

The image-before-adjustment generation unit 206 generates image data before adjustment according to equation (3) using the obtained light-field data, focal length information, and development parameters, and outputs the image data before adjustment to the display device 111 (S703).

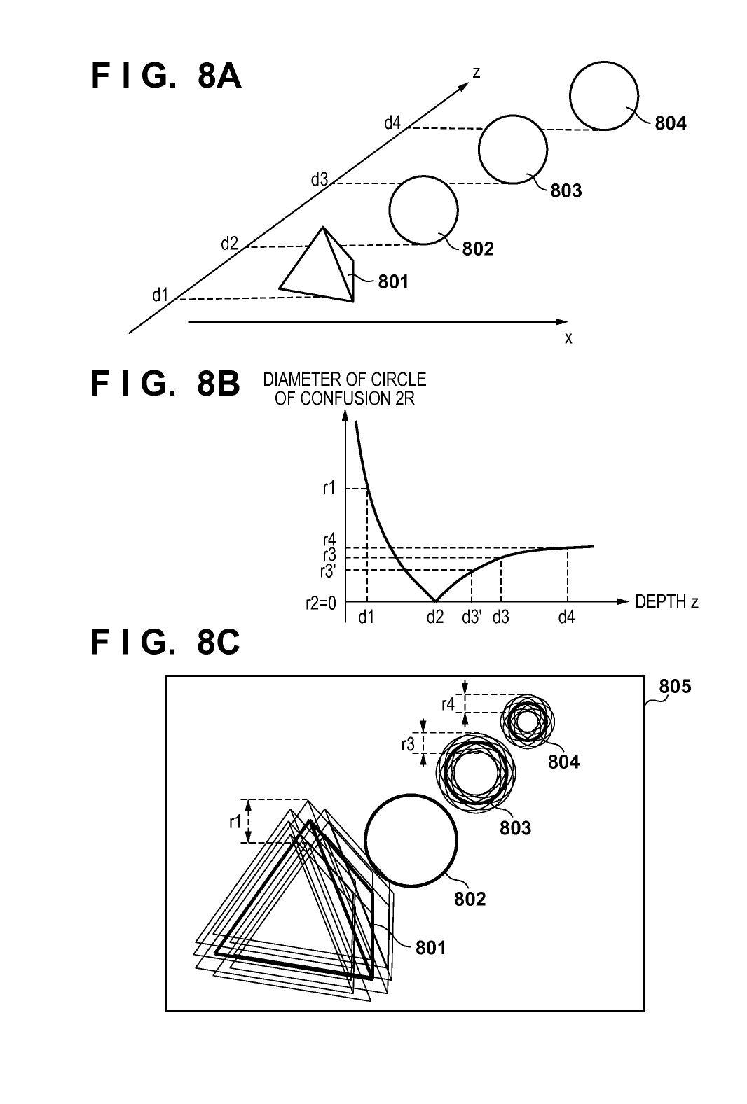

The image data before adjustment will be described with reference to FIGS. 8A to 8C. FIG. 8A shows positions at which a plurality of subjects exist. Subjects 801, 802, 803, and 804 exist at positions corresponding to depths d1, d2, d3, and d4 along the z-axis, respectively. FIG. 8B shows an example of the relationship between a depth z and the diameter 2R of a circle of confusion when the depth d2 is set as a focused position. FIG. 8C shows an example of drawing of image data before adjustment generated in this relationship.

In an image 805 before adjustment shown in FIG. 8C, the subject 802 existing at the depth d2 is in focus (a diameter r2 of a circle of confusion is 0). With respect to the remaining subjects, blurs of circles of confusion with diameters r1, r3, and r4 corresponding to the depths d1, d3, and d4 of the subjects occur. The generated image data before adjustment is displayed on the display device 111 as a reference image, as described above.

The conversion parameter obtaining unit 204 displays, on the display device 111, the sense-of-depth adjustment UI shown in FIG. 5, obtains a user instruction through the sense-of-depth adjustment UI, and generates a conversion parameter (S704). At this time, by simultaneously displaying the image before adjustment and the sense-of-depth adjustment UI, the user can modify the shape of the curve 501 indicating the correspondence between the depth positions before and after adjustment by operating the sense-of-depth adjustment UI with reference to the image 805 before adjustment.

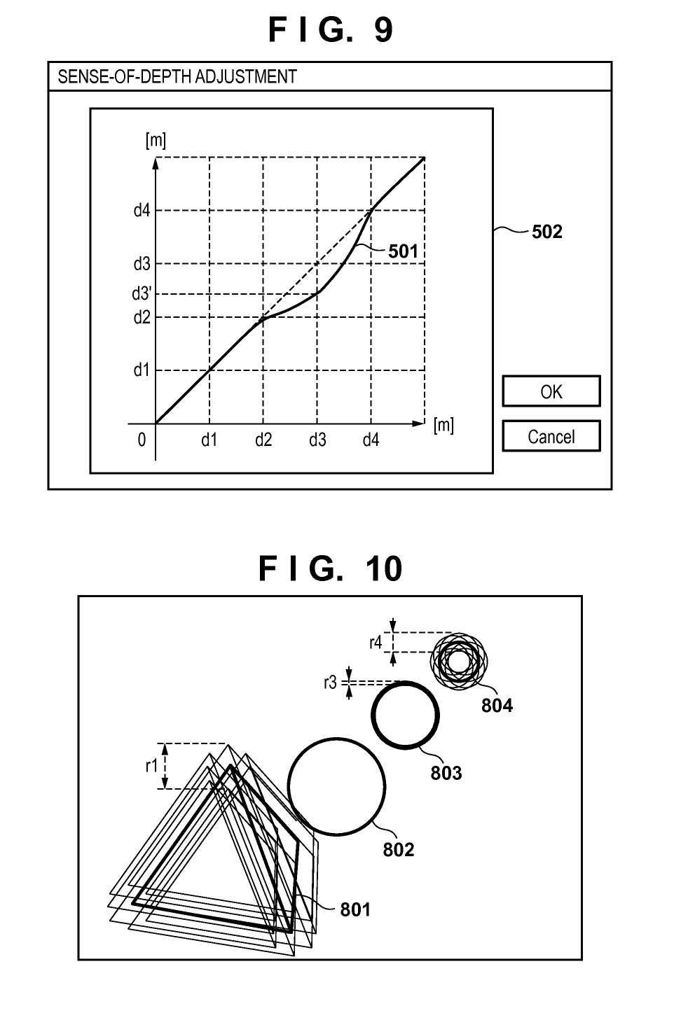

FIG. 9 shows an example of a user instruction for the image 805 before adjustment, which is input through the sense-of-depth adjustment UI. FIG. 9 shows a case in which the shape of the curve 501 is adjusted so that the depth of the subject existing near the depth d3 before adjustment becomes d3′ smaller than d3. This adjusts the sense of depth to look as if the subject near the depth d3 existed at the depth d3′ smaller than the actual depth, as shown in FIG. 8B.

The depth conversion unit 205 generates depth-after-adjustment information by converting the depth-before-adjustment information based on the conversion parameter (S705).

Next, the image-after-adjustment generation unit 207 generates image data after adjustment using the light-field data, focal length information, development parameters, depth-before-adjustment information, and depth-after-adjustment information (S706). Image data after adjustment is generated according to equations (4) to (6) above. FIG. 10 shows an example of drawing of an image after adjustment which is generated according to the user instruction shown in FIG. 9. Referring to FIG. 10, the blur amount of the subject 803 changes from that shown in FIG. 8C to look as if the subject 803 existed before the actual depth position but the blur amounts of the remaining subjects 801, 802, and 804 remain unchanged from the blur amounts shown in FIG. 8C.

The generated image data after adjustment is supplied to the display device 111, and the image after adjustment shown in FIG. 10 is displayed, as described above. By displaying the image after adjustment shown in FIG. 10 on the display device 111 together with the image before adjustment shown in FIG. 8C and the sense-of-depth adjustment UI shown in FIG. 5, the user can further perform fine adjustment by operating the sense-of-depth adjustment UI with reference to the images before and after adjustment. Although not shown in FIG. 7, the processes in steps S704 to S706 are repeated.

As described above, it is possible to issue an instruction to adjust the sense of depth for each depth, and set a depth for each subject with a different depth, thereby adjusting a blur amount. Therefore, it is possible to adjust the blur amount of an arbitrary subject without limitation to the actual depth of the subject by setting the depth for the subject by an intuitive user operation, thereby readily controlling the sense of depth of the image.

### Second Embodiment

An image processing apparatus and a method therefor according to the second embodiment of the present invention will be described below. Note that the same reference numerals as those in the first embodiment denote the same components in the second embodiment and a detailed description thereof may be omitted.

In the above-described first embodiment, the method of generating an image, in which a blur amount is adjusted according to a depth, using light field data has been explained. In the second embodiment, a case in which a blur amount is adjusted using general shot image data and corresponding depth data will be described. Note that image data used in the second embodiment is data of an image (that is, a pan-focus image) in which all subjects fall within the depth of filed.

[Arrangement of Image Processing Apparatus]

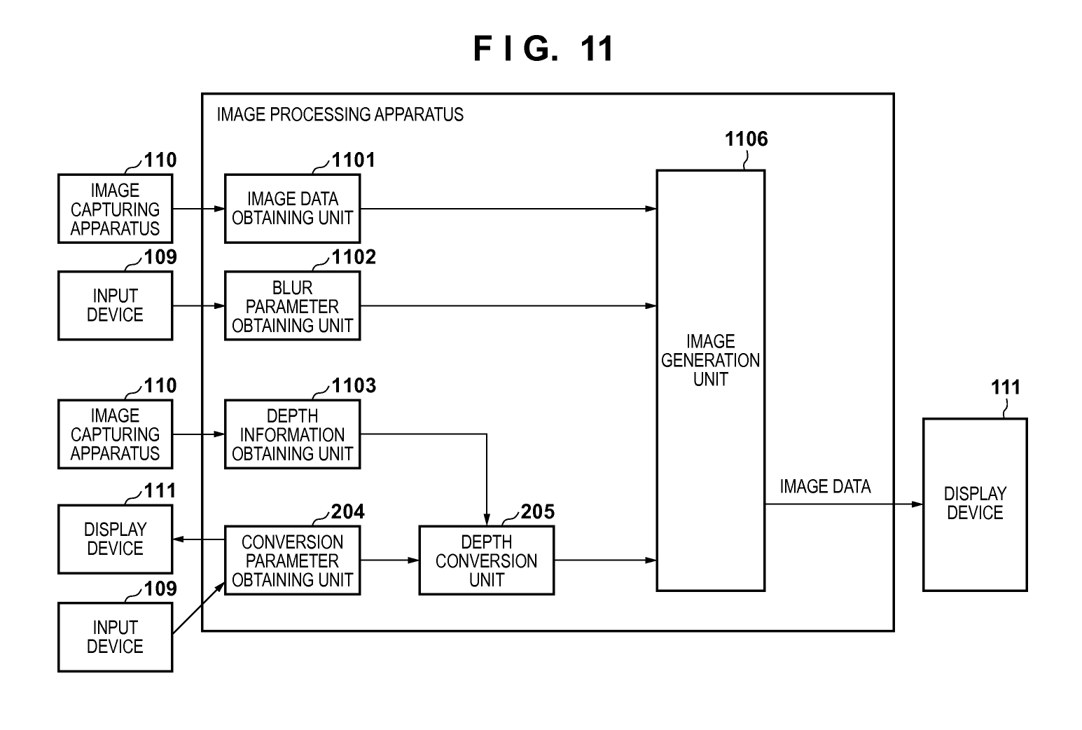

FIG. 11 shows the processing arrangement of an image processing apparatus according to the second embodiment. The image processing apparatus according to the second embodiment includes an image data obtaining unit 1101, a blur parameter obtaining unit 1102, a depth information obtaining unit 1103, a conversion parameter obtaining unit 204, a depth conversion unit 205, and an image generation unit 1106. Note that the operations of the conversion parameter obtaining unit 204 and depth conversion unit 205 are the same as those in the first embodiment and a description thereof will be omitted.

The image data obtaining unit 1101 obtains image data to be processed from an image capturing apparatus 110 through a general-purpose I/F 106. Alternatively, the image data obtaining unit 1101 may obtain image data from a storage unit 104 or the like through an HDD I/F 105. The obtained image data is supplied to the image generation unit 1106 as input image data.

The blur parameter obtaining unit 1102 obtains a blur parameter indicating the correspondence between a blur amount and a distance in the depth direction. For example, a conversion function whose input is a subject distance and whose output is the diameter of a circle of confusion is obtained as a blur parameter according to a user instruction input through the general-purpose I/F 106. Note that the conversion function may be directly input by the user or may be calculated by the blur parameter obtaining unit 1102 based on optical conditions such as the focal length, focused position, and f-number designated by the user. The obtained blur parameter is supplied to the image generation unit 1106.

The depth information obtaining unit 1103 obtains depth information indicating a subject distance in the input image data. For example, the depth information obtaining unit 1103 obtains, as depth-before-adjustment information, through the general-purpose I/F 106, a distance image of a subject created at the time of capturing the input image data by the image capturing apparatus 110 including a distance measurement unit such as a distance sensor. Alternatively, the depth information obtaining unit 1103 may obtain, through the HDD I/F 105, a distance image recorded in the storage unit 104 in association with the image data. The distance image obtained as depth-before-adjustment information is supplied to the depth conversion unit 205, converted by the depth conversion unit 205 according to a conversion parameter as in the first embodiment, and then supplied to the image generation unit 1106 as depth-after-adjustment information.

The image generation unit 1106 generates image data by applying, to the input image data, a blur based on the blur parameter and depth-after-adjustment information. That is, for each pixel of the input image data, the diameter of a circle of confusion corresponding to the subject distance after adjustment is obtained in accordance with the blur parameter, and a blur filter having the obtained diameter as a filter diameter is applied, thereby generating image data. As the blur filter, various smoothing filters such as a Gaussian filter and median filter are applicable. The generated image data is supplied to the display device 111, and an output image is displayed.

[Image Generation Processing]

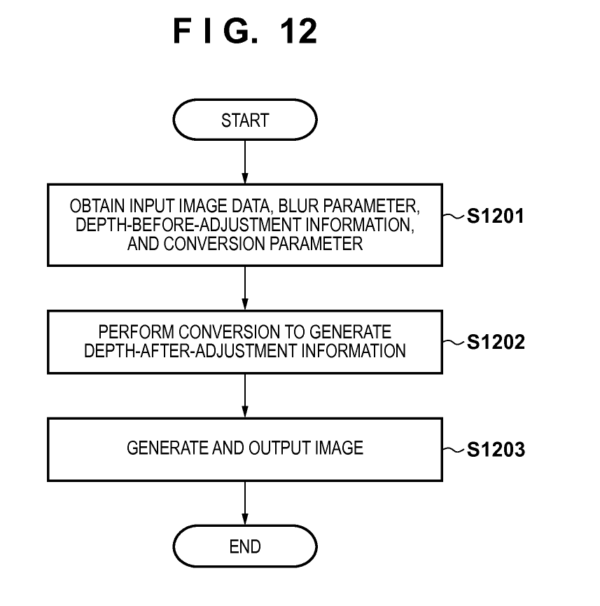

FIG. 12 is a flowchart illustrating image generation processing executed by the image processing apparatus according to the second embodiment. The processing shown in FIG. 12 is implemented when a CPU 101 loads a program, in which the following procedure is described and which is executable by a computer, from the storage unit 104 into a RAM 102, and executes the program.

Each obtaining unit obtains each data through the general-purpose I/F 106 or HDD I/F 105 (S1201). That is, the image data obtaining unit 1101 obtains input image data, the blur parameter obtaining unit 1102 obtains a blur parameter, the depth information obtaining unit 1103 obtains depth-before-adjustment information, and the conversion parameter obtaining unit 204 obtains a conversion parameter.

The depth conversion unit 205 converts the depth-before-adjustment information according to the conversion parameter, thereby generating depth-after-adjustment information (S1202).

By using the blur parameter and depth-after-adjustment information, the image generation unit 1106 generates image data by applying a blur to an input image indicated by the input image data (S1203). The generated image data is supplied to the display device 111, and an output image is displayed, as described above.

It is possible to adjust the blur amount of an arbitrary subject even for an image shot by a general image capturing apparatus, thereby readily controlling the sense of depth of the image.

### Third Embodiment

An image processing apparatus and a method therefor according to the third embodiment of the present invention will be described below. Note that the same reference numerals as those in the first and second embodiments denote the same components in the third embodiment and a detailed description thereof may be omitted.

Parallax images used to display a three-dimensional image include a set of two images. An observer is allowed to perceive a stereoscopic image of a subject using a binocular parallax by observing one image with the left eye and the other image with the right eye. Note that the image observed by the left eye will be referred to as a “left-eye image” hereinafter and the image observed by the right eye will be referred to as a “right-eye image” hereinafter.

Various guidelines for requiring the consideration of the visual load on an observer caused by inconsistency between adjustment and convergence in generation of parallax images have been stipulated at home and abroad. There is also known a technique of adjusting a parallax so that a range from the maximum value to the minimum value of the depth of a subject falls within the depth of field of an eye optical system so as to comfortably observe a stereoscopic image. In the conventional technique, however, since a parallax is made to fall within a limited range, the depth of a scene becomes smaller than that before parallax adjustment, thereby causing the observer to often feel that the sense of depth is not enough.

The image processing apparatus according to the third embodiment visually cancels a change in depth of a subject caused by parallax adjustment by adding, to parallax images, blur representation corresponding to the change in depth caused by parallax adjustment, thereby maintaining the sense of depth of a scene.

[Arrangement of Image Processing Apparatus]

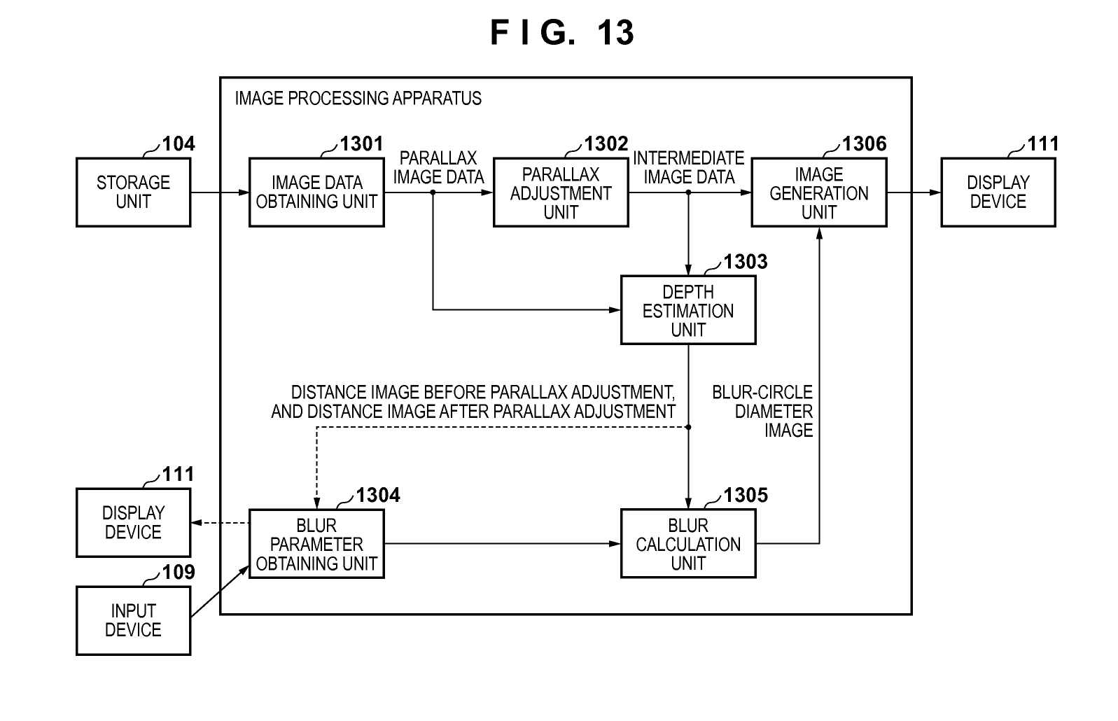

FIG. 13 is a block diagram showing the processing arrangement of the image processing apparatus according to the third embodiment. The image processing apparatus includes an image data obtaining unit 1301, a parallax adjustment unit 1302, a depth estimation unit 1303, a blur parameter obtaining unit 1304, a blur calculation unit 1305, and an image generation unit 1306.

The image data obtaining unit 1301 obtains parallax image data including a left-eye image, a right-eye image, and camera parameters (an angle of view, and left and right image capturing viewpoint positions) from a storage unit 104 or the like through an HDD I/F 105. Alternatively, the image data obtaining unit 1301 may obtain parallax image data directly from an image capturing apparatus 110 through a general-purpose I/F 106. The parallax image data may be captured by, for example, a multiple-lens camera, or generated using commercial three-dimensional image generation software. The obtained parallax image data is supplied to the parallax adjustment unit 1302 and depth estimation unit 1303 as input image data.

The parallax adjustment unit 1302 adjusts the parallax between the left-eye image and the right-eye image by, for example, setting one of the parallax images as a reference image and the other image as a non-reference image, and shifting pixels of the non-reference image in the horizontal direction. Various known parallax adjustment methods are applicable to parallax adjustment processing. For example, a method of normalizing the parallax between the left-eye image and the right-eye image in accordance with an allowable maximum parallax is applicable. The non-reference image after parallax adjustment is supplied to the depth estimation unit 1303 and image generation unit 1306 as intermediate image data together with the reference image.

The depth estimation unit 1303 estimates a distance in the depth direction for a subject in the parallax images, and generates a distance image. In the third embodiment, a distance is estimated using a known stereo method. More specifically, first, a region S(i, j) formed from a pixel D(i, j) of interest and its neighboring pixels in the reference image is selected. Pattern matching is performed using an image of the region S(i, j) as a template to search for a pixel D′(i′, j′) in the non-reference image corresponding to the pixel D(i, j) of interest. A subject distance p(i,j) corresponding to the pixel D(i, j) of interest is calculated based on the principle of triangulation using the pixel D(i, j) of interest, the corresponding pixel D′(i′, j′), and the camera parameters. When the above processing is applied to all the pixels of the reference image, a distance image having the subject distance p(i, j) as a pixel value is generated. The generated distance image is supplied to the blur calculation unit 1305.

The blur parameter obtaining unit 1304 obtains a blur parameter indicating the correspondence between the blur amount and the distance in the depth direction. In the third embodiment, according to a user instruction input through the general-purpose I/F 106, the blur parameter obtaining unit 1304 obtains, as blur parameters, a focal length f, focused position a, and f-number F of a lens at the time of capturing an input image. Alternatively, the blur parameter obtaining unit 1304 may obtain blur parameters from the image capturing apparatus 110 through the general-purpose I/F 106. The obtained blur parameters are supplied to the blur calculation unit 1305.

Based on the blur parameters and the distance images for the parallax images before and after parallax adjustment, the blur calculation unit 1305 calculates a blur amount (the diameter of a circle of confusion) which visually cancels a change in depth before and after parallax adjustment, thereby generating an image (to be referred to as a “blur-circle diameter image” hereinafter) indicating the diameter of a circle of confusion corresponding to a blur amount applied to each pixel. In the third embodiment, the diameter of a circle of confusion when a subject is moved in a direction opposite to that of a change in depth caused by parallax adjustment, that is, in a direction away from the focused position of the image is calculated for each pixel of the parallax image.

First, for each pixel position (i, j), a change amount Δz(i, j) of the depth caused by parallax adjustment is calculated by:

Δz(i, j)=p₁(i, j)−p₀(i, j) (7)

where p₀(i, j) represents a pixel value of the distance image for the parallax images before parallax adjustment, and

p₁(i, j) represents a pixel value of the distance image for the parallax images after parallax adjustment.

A depth z′(i, j) when the subject is moved in the direction opposite to that of the change in depth caused by parallax adjustment is calculated by:

z′(i, j)=p₀(i, j)−Δz(i, j) (8)

A diameter 2R(i, j) of the circle of confusion is calculated by substituting the obtained depth z′(i, j) into a depth position z′_{obj}(x_{img}) after adjustment of equation (4) described in the first embodiment, thereby generating a blur-circle diameter image having the pixel value 2R(i, j). At this time, the diameter 2R(i, j) of the circle of confusion is given by:

2R(i, j)=(f²/Fα)·|z′(i, j)−α|/z′(i, j) (9)

The generated blur-circle diameter image is supplied to the image generation unit 1306. Note that a distance image p₁ after parallax adjustment in the third embodiment corresponds to the depth-before-adjustment information in the second embodiment, and the depth z′ calculated according to equation (8) corresponds to the depth-after-adjustment information. Therefore, a table indicating the correspondence between the distance image p₁ and the depth z′ or the like corresponds to the depth conversion parameter in the second embodiment.

The image generation unit 1306 generates image data by applying a blur filter having the pixel value of the blur-circle diameter image as a filter diameter to each pixel of the parallax image indicated by the intermediate image data. As the blur filter, various smoothing filters such as a Gaussian filter and median filter are applicable. The generated image data is supplied to the display device 111, and an output image is displayed.

[Image Generation Processing]

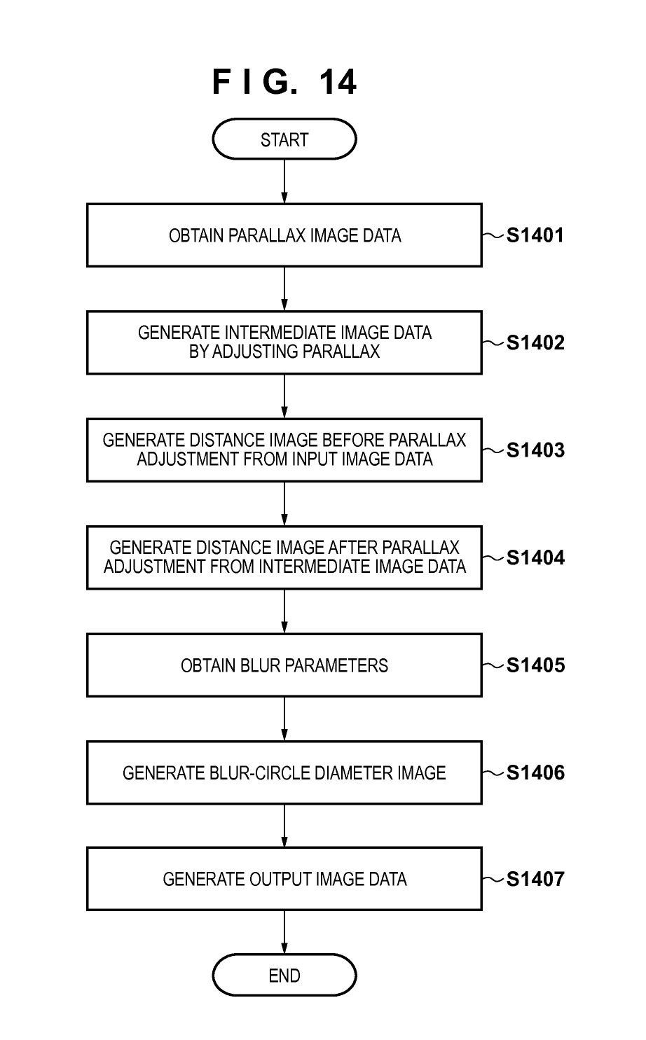

Image generation processing executed by the image processing apparatus according to the third embodiment will be described with reference to a flowchart shown in FIG. 14. The processing shown in FIG. 14 is implemented when a CPU 101 loads a program, in which the following procedure is described and which is executable by a computer, from a storage unit 104 into a RAM 102, and executes the program.

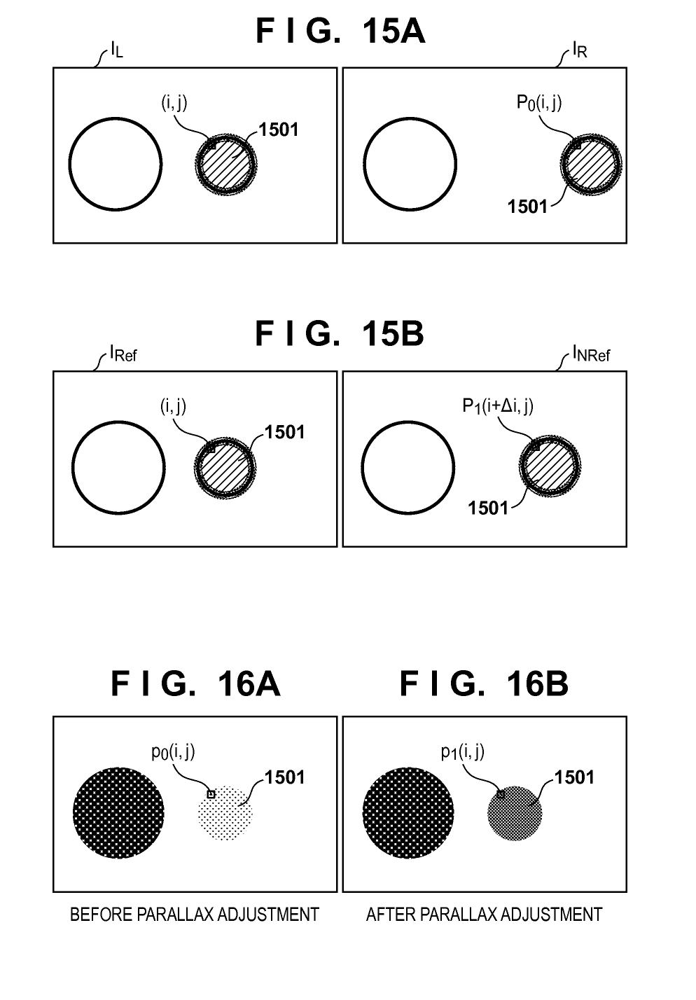

The image data obtaining unit 1301 obtains parallax image data through the general-purpose I/F 106, and outputs the obtained parallax image data as input image data to the parallax adjustment unit 1302 and depth estimation unit 1303 (S1401). FIG. 15A shows examples of a left-eye image I_{L} and right-eye image I_{R} included in the parallax image data.

The parallax adjustment unit 1302 generates intermediate image data by adjusting the parallax between the parallax images included in the input image data, and outputs the generated intermediate image data to the depth estimation unit 1303 and image generation unit 1306 (S1402). FIG. 15B shows an example of the intermediate image data. In the example shown in FIG. 15B, the left-eye image I_{L} serves as a reference image I_{Ref}, and the reference image I_{Ref} shown in FIG. 15B is the same as the left-eye image I_{L} shown in FIG. 15A. A non-reference image I_{NRef} shown in FIG. 15B is an image obtained by adjusting the parallax of a subject 1501 with respect to the right-eye image I_{R} shown in FIG. 15A. In other words, the non-reference image I_{NRef} is an image obtained by shifting, by Δi, pixels corresponding to the subject 1501 in a direction in which the parallax becomes small.

The depth estimation unit 1303 generates a distance image before parallax adjustment using the input image data, and outputs the generated distance image before parallax adjustment to the blur calculation unit 1305 (S1403). FIG. 16A shows an example of the distance image before parallax adjustment generated from the parallax images (FIG. 15A). Note that a pixel value in the distance image becomes larger in proportion to the subject distance. As a subject exists farther, corresponding pixel values are larger. As a subject exists on the nearer side, corresponding pixel values are smaller. Therefore, when the distance image is referred to as a luminance image, the background is expressed with white as infinity, a farther subject is brighter, and a nearer subject is darker.

The depth estimation unit 1303 generates a distance image after parallax adjustment using the intermediate image data, and outputs the generated distance image after parallax adjustment to the blur calculation unit 1305 (S1404). FIG. 16B shows an example of the distance image after parallax adjustment generated from the parallax images (FIG. 15B). By paying attention to the pixel values corresponding to the subject 1501 in the distance images shown in FIGS. 16A and 16B, the pixel values in the distance image (FIG. 16B) after parallax adjustment are smaller than those in the distance image (FIG. 16A) before parallax adjustment. That is, this indicates that the depth of the subject 1501 becomes smaller after parallax adjustment.

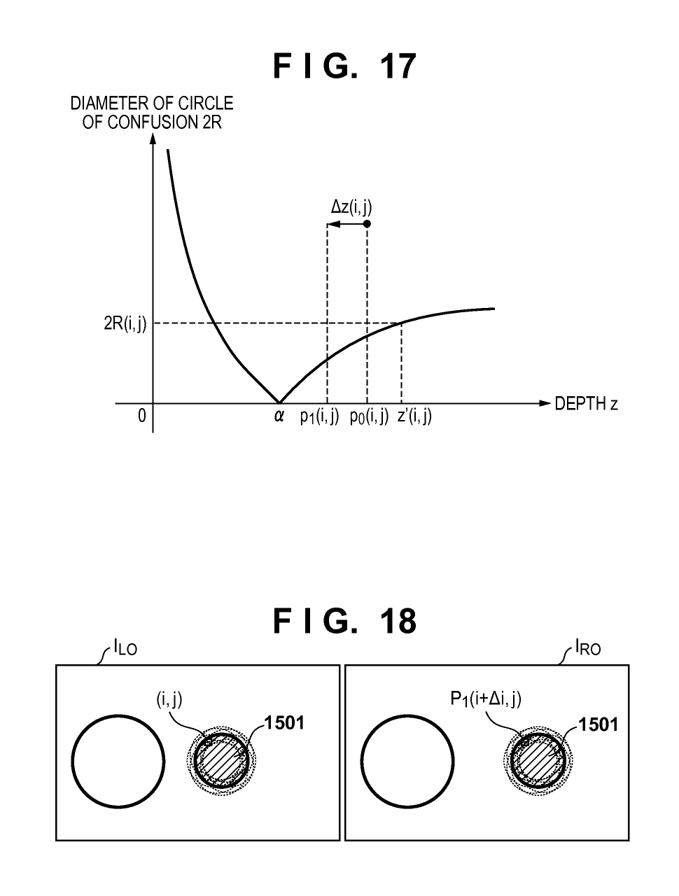

The blur parameter obtaining unit 1304 obtains blur parameters (focal length f, focused position α, and f-number F) through the general-purpose I/F 106, and outputs the obtained blur parameters to the blur calculation unit 1305 (S1405). FIG. 17 shows an example of the relationship between a depth z determined by the blur parameters and the diameter 2R of the circle of confusion.

The blur calculation unit 1305 generates a blur-circle diameter image using the distance images before and after parallax adjustment and the blur parameters, and outputs the generated blur-circle diameter image to the image generation unit 1306 (S1406). Note that the blur parameter obtaining unit 1304 may generate a sense-of-depth adjustment UI shown in FIG. 5 based on the two distance images generated by the depth estimation unit 1303, and display the UI on the display device 111. In this case, the UI is displayed so that a diagonal broken line shown in FIG. 5 corresponds to p₁, and a curve 501 corresponds to z′. If the user adjusts the shape of the curve 501, the blur parameter obtaining unit 1304 causes the blur calculation unit 1305 to update the blur-circle diameter image accordingly. In other words, the blur parameter obtaining unit 1304 generates a graph 502 indicating the difference between the distance image (FIG. 16A) before parallax adjustment and the distance image (FIG. 16B) after parallax adjustment which have been generated by the depth estimation unit 1303, and the relationship between the subject distance before parallax adjustment and an image blur amount estimated when moving the subject in the direction away from the focused position, and displays the sense-of-depth adjustment UI shown in FIG. 5.

The image generation unit 1306 generates output image data using the intermediate image data and blur-circle diameter image, and outputs the generated output image data to the display device 111 (S1407). FIG. 18 shows examples of a left-eye image I_{LO} and right-eye image I_{RO} of parallax image data output as output image data. The positions of the subjects in the left-eye image I_{LO} are the same as those in the intermediate image I_{Ref} shown in FIG. 15B, and the positions of the subjects in the right-eye image I_{RO} are the same as those in the intermediate image I_{NRef} shown in FIG. 15B. Note that the subject 1501 whose depth becomes smaller due to parallax adjustment is applied with a blur of an amount which gives the sense of depth to look as if the subject 1501 were at a deeper position.

As described above, in parallax adjustment of the parallax images, it is possible to improve the problem that the sense of depth of a scene becomes smaller after parallax adjustment, thereby maintaining the sense of depth.

Note that a case in which the image generation unit 1306 uses a blur filter has been explained above. However, it is possible to obtain the same effects by generating an image with a blur corresponding to a blur-circle diameter image using a known refocusing technique.

### Modification of Embodiments

In each of the above-described embodiments, a case in which an image shot using an image capturing apparatus is a processing target has been mainly described. Each embodiment, however, is applicable when an image created by computer graphics or the like is a processing target.

The image 502 included in the sense-of-depth adjustment UI shown in FIG. 5 or 9 indicates an image blur amount applied to an image of a subject positioned at a given subject distance or a subject distance corresponding to an image blur applied to a subject positioned at a given subject distance. Furthermore, the image 502 represents the correspondence between a subject distance and an image blur amount using a graph on a two-dimensional plane defined by the first coordinate axis corresponding to the subject distance and the second coordinate axis corresponding to the image blur amount.

### Other Embodiment

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2014-083990 filed Apr. 15, 2014 and 2015-060014 filed Mar. 23, 2015 which are hereby incorporated by reference herein in their entirety.

What is claimed is:

1. An image processing apparatus comprising:
a first obtaining unit configured to obtain image data;
a second obtaining unit configured to obtain distance information of subjects contained in the image data;
an interface generation unit configured to generate a user interface including an image which represents a correspondence between a distance of a subject and image blur, and to obtain a parameter indicating the correspondence between the subject distance and the image blur, based on an instruction input through the user interface and to set the correspondence between the subject distance and the image blur; and
an image generation unit configured to generate image data having a blur condition corresponding to the correspondence in accordance with the instruction, based on the image data, the distance information, and the parameter,
wherein at least one of the first to third obtaining units, the interface generation unit, or the image generation unit is implemented using a processor.

2. The apparatus according to claim 1, wherein the image generation unit comprises a conversion unit configured to convert the subject distance indicated by the distance information into a subject distance to be represented by the image data to be generated.

3. The apparatus according to claim 1, wherein the image representing the correspondence indicates a size of the image blur applied to an image of a subject located in a certain subject distance.

4. The apparatus according to claim 1, wherein the image representing the correspondence indicates a distance corresponding to a size of the image blur to be applied to an image of a subject located in a certain subject distance.

5. The apparatus according to claim 1, wherein the image representing the correspondence expresses the correspondence using a graph on a two dimensional plane that is defined by a first coordinate axis corresponding to the subject distance and a second coordinate axis corresponding to a size of the image blur.

6. The apparatus according to claim 1, wherein, in a case where an instruction for modifying the correspondence is input, the interface generation unit updates the image representing the correspondence based on the instruction.

7. The apparatus according to claim 1, wherein the interface generation unit generates, as the user interface, an image containing the image representing the correspondence, and an image which represents the blur condition based on the correspondence.

8. The apparatus according to claim 1, wherein the parameter comprises information indicating a correspondence between an actual subject distance represented by the distance information and a virtual distance corresponding to a size of the image blur.

9. The apparatus according to claim 1, wherein the image generation unit applies blur to the image data using filter processing based on the distance information and the parameter so as to generate the image data having the blur condition corresponding to the correspondence in accordance with the instruction.

10. The apparatus according to claim 9, wherein the first obtaining unit obtains parallax image data containing images which represent a same subject and have a parallax, and
the image generation unit performs the filter processing on the parallax image data so as to generate the image data having the blur condition corresponding to the correspondence in accordance with the instruction.

11. The apparatus according to claim 10, further comprising an adjustment unit configured to adjust the parallax to reduce the parallax between the images of the parallax image data,
wherein the interface generation unit generates the image representing the correspondence based on a relationship between parallaxes before and after the adjustment in the images of the parallax image data.

12. The apparatus according to claim 11, wherein the second obtaining unit obtains a distance before adjustment, which indicates a subject distance of a subject of the images contained in the parallax image data, based on the parallax of the images, and further obtains a distance after adjustment which indicates the subject distance of the subject based on the parallax after the adjustment, and
wherein the interface generation unit generates an image representing a relationship between the distance before adjustment and a size of the image blur assumed in a case where the subject is moved by a difference between the distance before adjustment and the distance after adjustment, in a direction away from a focal position.

13. An image processing method comprising: using a processor to perform steps of:
obtaining image data;
obtaining distance information of subjects contained in the image data;
generating a user interface including an image which represents a correspondence between a distance of a subject and image blur;
obtaining a parameter indicating the correspondence between the subject distance and the image blur, based on an instruction input through the user interface and to set the correspondence between the subject distance and the image blur; and
generating image data having a blur condition corresponding to the correspondence in accordance with the instruction, based on the image data, the distance information, and the parameter.

14. A non-transitory computer readable medium storing a computer-executable program for causing a computer to perform an image processing method, the method comprising steps of:
obtaining image data;
obtaining distance information of subjects contained in the image data;
generating a user interface including an image which represents a correspondence between a distance of a subject and image blur;
obtaining a parameter indicating the correspondence between the subject distance and the image blur, based on an instruction input through the user interface and to set the correspondence between the subject distance and the image blur; and
generating image data having a blur condition corresponding to the correspondence in accordance with the instruction, based on the image data, the distance information, and the parameter.
